(19) United States
(12) Patent Application Publication
(10) Pub. No.: US 2015/0302409 A1
(43) Pub. Date: Oct. 22, 2015

(54) SYSTEM AND METHOD FOR LOCATION-BASED FINANCIAL TRANSACTION AUTHENTICATION

(71) Applicants: Behzad Malek, Toronto (CA); Ali Miri, Toronto (CA)

(72) Inventors: Behzad Malek, Toronto (CA); Ali Miri, Toronto (CA)

(21) Appl. No.: 14/443,168

(22) PCT Filed: Nov. 15, 2012
(86) PCT No.: PCT/CA2012/001049

§ 371 Date: May 15, 2015

(51) Int. Cl. G06Q 20/40; G06Q 20/32; G06Q 20/38

(52) U.S. Cl. CPC G06Q 20/405; G06Q 20/3829; G06Q 20/385; G06Q 20/3224

(57) ABSTRACT

There is provided apparatus, systems and methods that secure payment systems and other financial transaction systems by integrating the location of the transaction into transaction (e.g. payment) authentication processing. One or more methods, apparatus and systems are provided for authenticating a financial transaction made by a payer using a financial transaction processing system such as a payment system. The location of the payer and at least a portion of the financial transaction processing system (e.g. a location of the point of transaction) are verified by an authentication system and confirmed by the payer using a payer communication device.

### TECHNICAL FIELD

This disclosure relates to financial transaction authentication using location information, such as for purchase transactions using a credit card, debit card or other payment instrument via a payment system or financial transactions at automated teller machines, or the like.

### BACKGROUND

Many widely available payment systems are vulnerable to attacks such as the relay attack. The relay attack is a fairly simple yet destructive attack where a fraudulent party tries to spoof the identity of a legitimate payer in order to bypass the payment authentication process of a Point of Transaction (POT) system. This is usually accomplished by presenting a spoofed card to the POT system and relaying payment authentication messages from the legitimate payer without consent. The relay attack is simple to implement: the fraudulent party provides a proxy to relay the authentication messages between the POT system and the legitimate payer without having to penetrate the payment authentication process. The proxy typically includes a tampered component of a POT system such as a POT terminal or device that is presented to the legitimate payer and that is configured to relay the legitimate payer information to the fraudulent party card instead of directly contacting the POT system payment authentication server. The relay attack succeeds mainly because legitimate payers do not have any way of distinguishing the proxy from an authentic POT device. They are not aware that they are authorizing a different transaction than the one that is being presented to them.

### SUMMARY

There is provided apparatus, systems and methods that secure payment systems and other financial transaction systems by integrating the location of the transaction into transaction (e.g. payment) authentication processing, presenting the location to the payer. One or more methods, apparatus and systems are provided for authenticating a financial transaction made by a payer using a financial transaction processing system such as a payment system. The location of the payer and at least a portion of the financial transaction processing system (e.g. a location of the point of transaction) are verified by an authentication system and confirmed by the payer using a payer communication device.

There is provided a method for authenticating a financial transaction, comprising: sending to a payer communication device financial information including location information related to the financial transaction and requesting confirmation of the financial transaction in association with the location; receiving from the payer communication device the confirmation; and in accordance with the confirmation, approving further processing of the financial transaction. In some examples, a payment may be made using a point of transaction (POT) system and the location information may comprise a geographic address for the point of transaction. In some examples, the financial transaction may be an e-commerce purchase transaction with payment made online or a telephone purchase transaction with payment made over the telephone. In either scenario, the location information may comprise a domain name address.

The method may comprise receiving from a POT system the financial information including the location information. In such a case, the method may comprise verifying the location information received against location information previously registered for the POT system. The purchase information received from the POT system may further comprise an identifier for the payer and the method may further comprise using the identifier to determine the payer communication device.

In some examples, the confirmation received may comprise an identification of a payment instrument with which to make a payment.

In some examples, approving further processing comprises initiating further processing of a payment in accordance with the confirmation. In such a case, the method may comprise sending to a payment system purchase information and payment information for processing the payment. The payment information may include payment instrument information with which to make the payment. The method may comprise receiving from the payer communication device an identification of the payment instrument.

In some examples, the method may comprise receiving from the payer communication device a request for a temporary identifier for a payer of the financial transaction; generating a temporary identifier and associating the temporary identifier with payer information previously stored for the payer; and sending to the payer communication device the temporary identifier for use to initiate the financial transaction. The method may also comprise receiving from a POT device the purchase information including the location information and the temporary identifier; and using the temporary identifier to access the payer information.

There is provided an apparatus for authenticating a financial transaction, comprising a transaction approval subsystem (for example a processor configured via software) configured to perform any one of the methods as just described.

There is provided a method for confirming a financial transaction, (for example, by execution by a payer communication device), the method comprising: receiving, from an apparatus for authenticating a financial transaction, at a communication device, a request to confirm financial information including location information related to the purchase transaction; and sending to the apparatus a confirmation for the financial transaction thereby to permit or deny further processing.

The method may comprise sending location information for the communication device for verifying by the apparatus against the location information related to the financial transaction. In some examples, the method operates such that, at least one of: the location information for the communication device is sent before receiving the request; and the location information for the communication device is sent after receiving the request.

The method may comprise sending an identifier for a payer to a POT device with which to initiate the financial transaction. The method may comprise receiving credentials for generating the confirmation. There is provided a communication device comprising a financial transaction confirmation subsystem configured to perform any one of the methods for confirming a purchase transaction as described.

There is provided a purchase transaction method, (for example, for execution by a payment system for a merchant, etc.) comprising: receiving an identifier of a payer for a purchase transaction; generating purchase information for the purchase transaction, said information including a location of the purchase transaction and the identifier; sending a request for payment including the purchase information to an apparatus for authenticating a purchase transaction, said apparatus configured to authenticate the purchase transaction in accordance with the location of the purchase transaction and a location of the payer for the transaction and further process payment in accordance with the authentication; and concluding the purchase transaction in accordance with the authentication by the apparatus. There is provided a payment system comprising a POT device configured to perform the payment method as just described.

There is provided a computer program media storing instructions for configuring a processor to perform any of the respective methods as just described.

There is provided a payment authentication network comprising an apparatus for authenticating a purchase transaction coupled for communication with one or more payment systems for performing a purchase transaction and one or more communication devices for confirming a purchase transaction made via the respective payment systems.

“Financial transactions” includes purchase transactions as described such as where payment is made using a payment instrument that is electronically processed. Financial transactions include banking transactions including automated teller transactions, online banking transactions and telephone banking transactions. “Point of Transaction” includes “Point of Sale” and “Point of Purchase” contexts for financial transactions. POT systems include POS systems, automated teller machines (ATMs), telephone banking systems and online websites where a user engages in a financial transaction.

### BRIEF DESCRIPTION OF THE FIGURES

FIG. 1 is block diagram of a payment authentication network in accordance with an example;

FIG. 2 is a graphical representation of operations comprising invocations and message flows in the network of FIG. 1 for payer setup in accordance with an example;

FIG. 3 is a graphical representation of operations comprising invocations and message flows in the network of FIG. 1 for merchant setup in accordance with an example;

FIG. 4 is a graphical representation of operations comprising invocations and message flows in the network of FIG. 1 for in-store identification in accordance with an example;

FIG. 5 is a graphical representation of operations comprising invocations and message flows in the network of FIG. 1 for online identification in accordance with an example;

FIG. 6 is a graphical representation of operations comprising invocations and message flows in the network of FIG. 1 for protecting privacy in an online or in-store identification in accordance with an example; and

FIG. 7 is a graphical representation of operations comprising invocations and message flows in the network of FIG. 1 for payment processing in accordance with an example.

### DETAILED DESCRIPTION

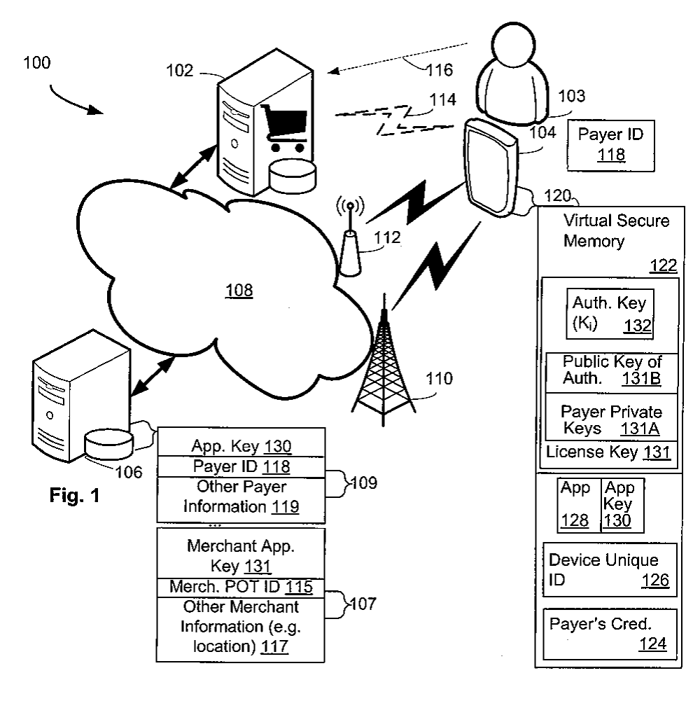

FIG. 1 is block diagram of a payment authentication network 100 in accordance with an example. Network 100 comprises, a Merchant POT system 102, a Payer device 104 and an Authenticator system 106 comprising one or more servers and abbreviated herein as Authenticator 106. Authenticator 106 is communicatively connected to POT system 102 and Payer device 104 via network 108. Payer device in the present example is a wireless communication device and is configured to connect wirelessly via wide area network 110 represented by a tower and/or a local area network 112 represented by an access point. As described further below, Payer device 104 may be configured to communicate with POT system 102 in a wireless manner such as via one or more short range communication technique (e.g. via infrared (IR), Bluetooth™, radio frequency identification (RFID), near field communication (NFC), etc.) represented by communication path 114 shown in broken lines. Alternatively Payer device 104 may communicate with POT system 102 via network 108. Also shown is a Payer 103 comprising a human user of Payer device 104. Payer 103 may communicate with POT system 102 and/or an operator thereof as represented by communication path 116 shown in broken lines. Though illustrated in the present example as a wireless communication device, Payer device 104 may be coupled to network 108 in a wired manner. In another alternative arrangement, Authenticator 106 may track a location of Payer device 104 (e.g. where such tracking is enabled, Payer device 104 may communicate location automatically to Authenticator 106) and automatically match the location of Payer device 104 and POT system 102. Payer device 104 need not communicate with POT system 102.

POT system 102 handles payments for products and/or services on behalf of a Merchant (not shown). Merchant POT system 102 can be in the form of a software/hardware that can communicate with Authenticator 106. Such a POT system 102 may comprise one or more of a POT device or terminal typically used to process payments via credit card, debit card, gift card, currency and other payment instruments, a tablet, a Smartphone, a laptop, a desktop or other computer or combinations thereof (such as a POT device coupled to a computer) which may communicate wirelessly or in a wired manner with communication network 108. It will be understood that payment authentication network 100 is illustrated in a simplified manner. Merchant POT system 102 may also be configured to communicate with other systems (not shown) such as other merchant systems (e.g. inventory systems, catalog systems, customer relationship management (CRM) and/or other bill processing systems), as well as third party systems, etc. Though often operated by a representative of the merchant, such as a cashier or sales associate, POT system 102 may be operated by Payer 103 in a self-checkout configuration.

Payer 103 is the entity who is purchasing products and/or services and has to remit a payment via a payment means and is represented as the human user that authorizes his/her Payer device 104 for payments. In some instances, the human user may be an individual who is permitted to use another individual's payer device and payment means. Payer device 104 may be a mobile communication device or a stationary communication device and can be in the form of any software/hardware that can, independently from POT system 102, communicate with the Authenticator 106. For example, Payer device 104 may comprise a tablet, a PDA, a Smartphone, a laptop, a desktop or other computer. Payer device 104, in some examples, is configured to provide the location of the Payer device 104 to Authenticator 106, such as automatically, for example, to match with the location of Merchant POT system 102. The location may be a geographical location. Payer device 104 may be configured to determine its location using satellite signals (not shown), (e.g. using GPS or other satellite navigation technologies), location beacons or network signals (e.g. using triangulation of signals from network 110 or a known location of network 112), or combinations thereof, etc. Payer device 104 may have such location determined on its behalf such as by a remote service (not shown) or by a POT system 102. Such a service may examine radio network signals (e.g. cellular, RFID, Bluetooth, etc.) for Payer device 104.

Authenticator 106 processes payment transactions, authorizing payment using location as described further herein. Authenticator 106 validates the charges and verifies both the Merchant (or the Merchant POT system 102) and the Payer device 104 (after its being authorized by the Payer). Authenticator 106 typically comprises one or more servers and storage devices (e.g. database) and/or other software/hardware that can communicate individually with the Payer device and the Merchant POT system 102. Authenticator 106 is configured to store information 107 for Merchant accounts and information 109 for Payer accounts to facilitate the authentication of payment transactions as described further herein. The merchant information 107 may comprise merchant POT ID 115 and other merchant information 117 such as location, merchant credential information, merchant name and address and the like. The payer information 109 may comprise Payer ID 118 and other payer information such as location, which may be automatically updated as described, payment instrument information, Payer financial information and the like. Though not shown Authenticator private and public keys may be locally stored for communicating with Payer device 104 and Merchant POT system 102. Authenticator 106 may also store a merchant app key 131, for example to authenticate merchant apps and to facilitate secure storage of merchant transaction authorization keys (not shown) as described further below.

It is understood that each of Merchant POT system 102, Payer device 104 and Authenticator 106 may comprise computing devices and/or systems comprising one or more programmable devices (e.g. processors, (microprocessors), programmable controllers, field-programmable gate arrays, etc.), memory, storage devices, communication sub-systems, I/O subsystems such as display screens (which may be touch screen enabled) and keyboards, buttons, etc.), which may be configured using software (e.g. instructions and/or data) for performing the operations described herein. When configured, the various systems may comprise subsystems and/or components for performing particular operations. The methods described herein may be embodied in computer program media that store the instructions and/or data such as memory, including read only memory (ROM), random access memory (RAM), flash drives, storage disks (including CDs, DVDs, etc,), tapes, etc. and may be embodied in computer program media that does not store the instructions per se, such as in transient signals. In at least some embodiments Payer device 104 comprises computer program media 120 (e.g. various memory and the like) for storing instructions and/or data for configuring and operating its programmable device (not shown). Computer program media 120 may be configured to define a virtual secure memory 122 using encryption techniques. Payer device 104 may comprise a payer's credentials component 124 for challenging the Payer 103 (e.g. verifying the Payer 103 via login and password and/or Personal Identification Number (PIN)) to authorize a financial transaction (e.g. by two factor authentication comprising the Payer device and credentials); a device unique identifier 126 for the Payer device 104 such as an Ethernet Media Access Control (MAC) address, Unique Device Identifier (UDID) or International Mobile Equipment Identity (IMEI); an application (“App”) 128 with which to authorize payment for the financial transaction; an App Key 130 associated with the App 128 and a license key 131 comprising a private key 131A and a public key 131B for the authenticator 106 and a transaction authorization key (Kᵢ) 132. The license key 131 is securely stored in the device memory 132 and is accessible by App 128 using device unique identifier 126. App 128 may use the transaction authorization key (Kᵢ) 132 to authorize a financial transaction as described further below. Authenticator 106 also stores App Key 130 as further described below. Authenticator 106 or another server system (not shown) may store App 128 for communicating to Payer devices (e.g. 104). Similarly, Merchant POT systems 102 and on-line systems (not shown) for purchase transactions or other financial transactions may receive appropriate applications and keys from Authenticator 106 or another server system. Authenticator 106 or another key issuing system may be configured to issue the various keys described.

In brief, Payer 103 may begin the process by providing a Payer ID 118 to Merchant POT system 102 to, depending on the location of the transaction, initiate an online or in-store transaction, to receive a Bill (not shown) from the POT system 102. Payer ID 118 may be communicated via path 114, 116 or network 108. In other embodiments, Payer ID 118 may be automatically sent by Authenticator 106 as described below.

The Bill issued by POT system 102 includes data to be verified by Authenticator 106, including Transaction Type (e.g. in-store or online), Merchant POT Identification (ID) 115, location of transaction (e.g. a geographic address for an in-store type and a domain name of the Merchant for an online type), Payer ID 118 and other common information used to issue a bill. As described further below, a Session ID (SID) may be used in place of a Payer ID 118. The Bill is sent to Authenticator 106 via a secure channel such as SSL, TLS or other encrypted channel via network 108. Authenticator 106 checks the validity of the Bill and verifies that the (current or permitted) location of the Payer 103 corresponds to the location of the Merchant given the Transaction Type being processed—if location tracking of the Payer device 104 is enabled. If Merchant POT system 102 is authenticated and the Bill is validated, the Bill is sent over to the Payer device 104 for further processing including authorization in response to Payer 103. Otherwise, Merchant POT system 102 is notified that the Bill cannot be accepted as prepared. The Merchant, depending on its own policies, might reissue the Bill, change the Transaction Type or ask the Payer to use another method to make a payment.

Payer device 104 is contacted by Authenticator 106 to authorize the payment of the Bill. Payer device 104 receives the Bill from Authenticator 106 over a secure channel, such as SSL, TLS or any other encrypted channel via network 108. Payer 103 verifies that the Bill contains a correct Amount, was issued by an authorized Merchant POT system and has occurred at a legitimate location. Payer 103 enters his/her personal credentials—which are explained later in this document to authorize the payment and Payer device 104 returns the confirmation response along with the current location of Payer 103 if location tracking is permitted.

Authenticator 106 receives the authorization response from the Payer (along with its current Location). If the location of Payer is provided, it is matched with the location declared in the Bill issued by the Merchant. Otherwise, the confirmation received from Payer device 104 supersedes the location matching of Payer device 104 with the Merchant POT system 102. Authenticator 106 processes the payment for transferring the funds from Payer 103 to the Merchant after receiving the Payer device 104 confirmation and possibly matching the locations. Finally, Authenticator 106 notifies the Payer 103 and the Merchant of the result of the payment and ends the transaction.

It is noted that in some embodiments Authenticator 106 may track the location of Payer device 104, for example, to match with a location of Merchant POT system 102. Authenticator 106 may receive location information such as via regular updates from Payer device 104. The updates may include the Payer Device location, Payer ID 118, identification preference (with ID or SID) and other relevant information to identify the Payer 103 and/or Payer Device 104. The updates are signed and sent to Authenticator 106 via a secure communications channel. Once Authenticator 106 determines that Payer device 104 is located within the proximity of a registered Merchant POT, Authenticator 106 sends the Payer ID 118 (or SID) to Merchant POT system 102 as an available Payer. In some examples at Merchant POT system 102, there might be only one ID/SID that is ready to pay at a time and Merchant POT system 102 may issue the Bill to the available ID/SID without further communication with the Payer 103.

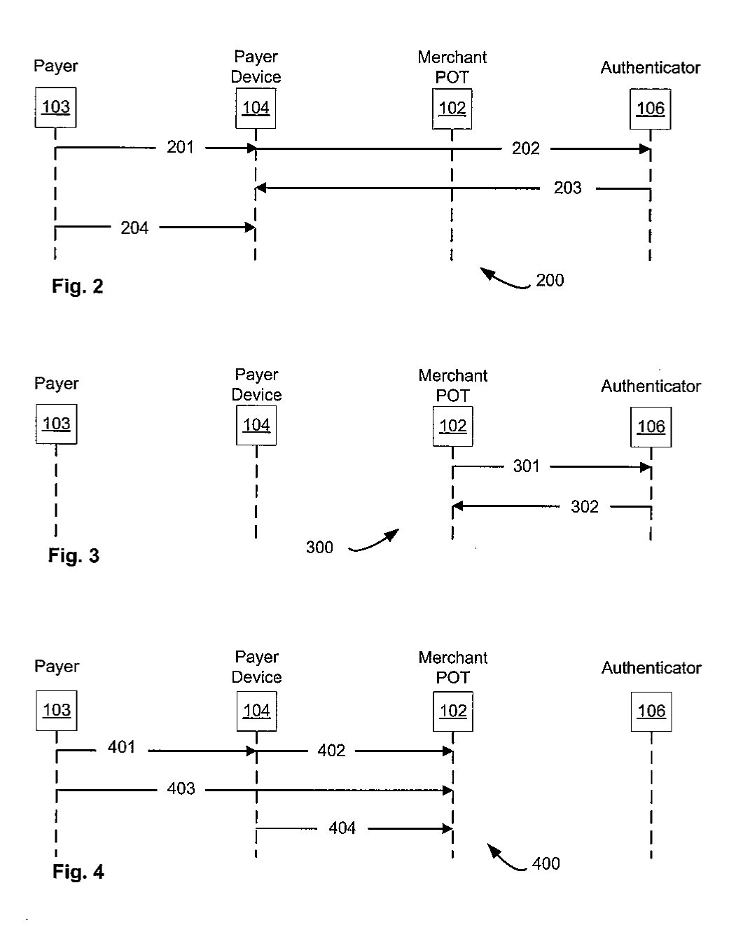

FIG. 2 illustrates an example of operations 200 for setting up a Payer account with Authenticator 106 and the configuration of Payer device 104 for use in location-based authentication of payments. In the setup stage, Payer 103 signs up to a payer account (flows 201 and 202) using device 104 with Authenticator 106, such as by agreeing to certain terms of service, setting a password, sharing their contact information, and providing payer payment method details such as a bank account, debit and/or credit card details. In some examples, more than one payment method may be provided and the Payer device 104 configured to select an appropriate method.

App 128 is installed on Payer device 104, for example under control of the Payer 103. The App 128 contains App key 130. The App key 130 uniquely identifies the App 128 that is running on the Payer device 104 and is being used for authorizing the payments. The App Key 130 might be secured in a portion of memory, sometimes referred to as a secure element on the Payer device 104 or might be hardcoded and protected inside the App 128 via code obfuscation techniques and the like. Upon registration with Authenticator 106, Payer 103 is assigned the unique ID 126 and a license key 131. The license key contains Payer private key(s) 131A, a public key 131B of Authenticator 106 and a transaction authorization key (Kᵢ). Payer private keys 131A are used to digitally sign messages from Payer device 104 and to decrypt payment authentication messages sent to Payer device 104. Public key 131 of Authenticator 106 is used to encrypt such messages to Authenticator 106. The same private key 131A might be used for digital signature and decryption, depending on the underlying cryptography scheme that is being implemented. Transaction authorization key (Kᵢ) 132 is used to authorize transactions via Payer device 104. The License key 131 may be stored in virtual secure memory 122. Though not shown, Authenticator 106 may store one or more private keys for sending encrypted communications such as to Payer device 104.

At flow 203, payment authorization software (e.g. App 128 or in an alternative embodiment a plug-in (not shown) to an existing application (not shown) on Payer device 104) is stored onto the Payer device 104. The license key is also stored onto the virtual secure memory 122 on the Payer device 104 upon registration and activating the App 128. At flow 204, Payer 103 invokes the payment authorization App 128 and a personalization process is initiated to protect the transaction authorization key (Kᵢ) 132. The personalization process can be initialized in one or a combination of the following personalization credentials:
as a textual, Personal Identification Number (PIN) that is only known to the Payer 103;
as the Payer's biometrics, such as fingerprints, face, voice, retina or signature (autograph) scan;
as a unique cryptographic key stored on a hardware/software token, USB stick or other device that must accompany the Payer 103;
as a unique cryptographic key written or displayed separately from the device, for example, printed on a plastic card including as a quick response (QR) code.

Transaction authorization key (Kᵢ) 132 might be also secured in a secure element on the Payer device 104 if it is available. Otherwise, a virtual secure memory 122 is configured to store Transaction authorization key (Kᵢ) 132. The virtual secure memory 122 is advantageous over a secure element, since it is independent from the device manufacturer or the wireless service provider. The data in virtual secure memory 122 are encrypted using a key (not shown) that is a combination of the device unique identifier 126 and App Key 130. The key to encrypt the data in the memory can simply be an XOR of the device unique identifier 126 and the App Key 130, a hash of the two keys concatenated or any other similar combinations. App Key 130 acts as the secret key shared between Authenticator 106 and App 128 that is granted access to virtual secure memory 122 on Payer device 104. Transaction authorization key (Kᵢ) 132, which is stored in virtual memory 122, is therefore protected by means of encryption and it is tightly bounded to the underlying hardware. Only authorized applications such as App 128 running on the Payer device 104 possessing the same App Key 130 can generate the encryption key and retrieve the transaction authorization key (Kᵢ) 132 stored in virtual secure memory 122. Furthermore, read/write access to transaction authorization key (Kᵢ) 132 is limited using the Payer's credentials 124 used in the personalization process. For example, access to the encrypted transaction authorization key (Kᵢ) 132 can be password protected using the Payer's PIN. Upon registration, the Payer 103 and Authenticator 106 participate in a challenge-response authentication mechanism using device unique ID 126 and App key 130 as the shared secret, in order to transfer transaction authorization key (Kᵢ) 132 in to virtual secure memory 122 on Payer device 104.

Transaction authorization key (Kᵢ) 132 binds the Payer 103 to Payer device 104 after the Payer 103 initializes the personalization process. Payer 103 is also asked to present his/her credentials to be checked in the personalization process before the transaction authorization key (Kᵢ) 132 is released to authorize a transaction.

Note that the Payer credentials 124 are stored with the Payer 103 or on his/her device 104 into the secure element if it is available on the Payer device 104. Otherwise, the Payer credentials 124 used in the personalization process are protected by a cryptographic hash function (e.g. SHA1, MD5, etc.) and used to limit access to virtual secure memory 122. On the other hand, the Payer authentication data (e.g. username/password) are stored with Authenticator 106. Payer 103 has to be authenticated to Authenticator 106 first and then provide correct personalization credentials to device 104 to approve a transaction. Payer 103 has the option to enable location tracking, in order to assist with location-based payment authentication. Otherwise authentication proceeds on the confirmation of the Payer 103 alone.

Though only one Payer device 104 is shown in the present example, a particular Payer 103 may configure multiple devices and/or have more than one account with Authenticator 106. In one example, the operations of flow 200 may be conducted online such as via network 108.

FIG. 3 illustrates an example of operations 300 for setting up a Merchant account with Authenticator 106 and the configuration of POT system 102 for use in location-based authentication of payments. In one example at flow 301, the Merchant (represented by POT system 102 however, another computer system or manner may be used for this flow) sets up a Merchant account with Authenticator 106, agreeing to terms of service, setting a username/password, providing payment details such as banking accounts, for receiving a transfer of funds.

The Merchant registers its Merchant POT system(s) with Authenticator 106. Note that the POT system 102 can be any in the form of software running on the Merchant device with connectivity to the Authenticator servers. Note that each Merchant can register multiple POT systems per location. When registering a POT system 102, the Merchant provides a location of the POT system 102 and proves its correctness to the Authenticator 106. Note that the location of the POT system 102 refers to its physical (geographic) location for in-store payments and refers to its domain name for online or telephone transactions. Authenticator 106 may verify the correctness of the locations. For example, a sales agent (not shown) of Authenticator 106 may perform a location visit. Authenticator 106 may require the Merchant to send in the physical location of its POT systems at the time of registration or check the domain name registry for ownership of a domain name.

At flow 302, upon registration with Authenticator 106, the Merchant and the Merchant POT systems (e.g. 102) are assigned a unique ID each. Merchant POT system 102 is further assigned a license key containing the public key of Authenticator 106 and private keys of Merchant POT system 102. As before, the public key of Authenticator 106 is to encrypt the communication for Authenticator 106. The private keys are to digitally sign messages originated from the Merchant POT system 102 and to decrypt the messages for the Merchant POT system 102.

Note that a Merchant Personalization Process (not shown) may also be implemented at the Merchant POT system, similar to the Payer device. Though not shown, a similar process may be utilized to create a virtual secure memory (not shown) on the Merchant POT system 102 to store the Merchant's private keys (not shown). Similarly, this will ensure that the Merchant's keys are only accessible from a known hardware, running authorized applications (not shown). Note that the requirement to limit the read/write access to the virtual secure memory on the Merchant POT system device might be waived, in order to streamline the payment processing by Merchant personnel or automatic agents of that system.

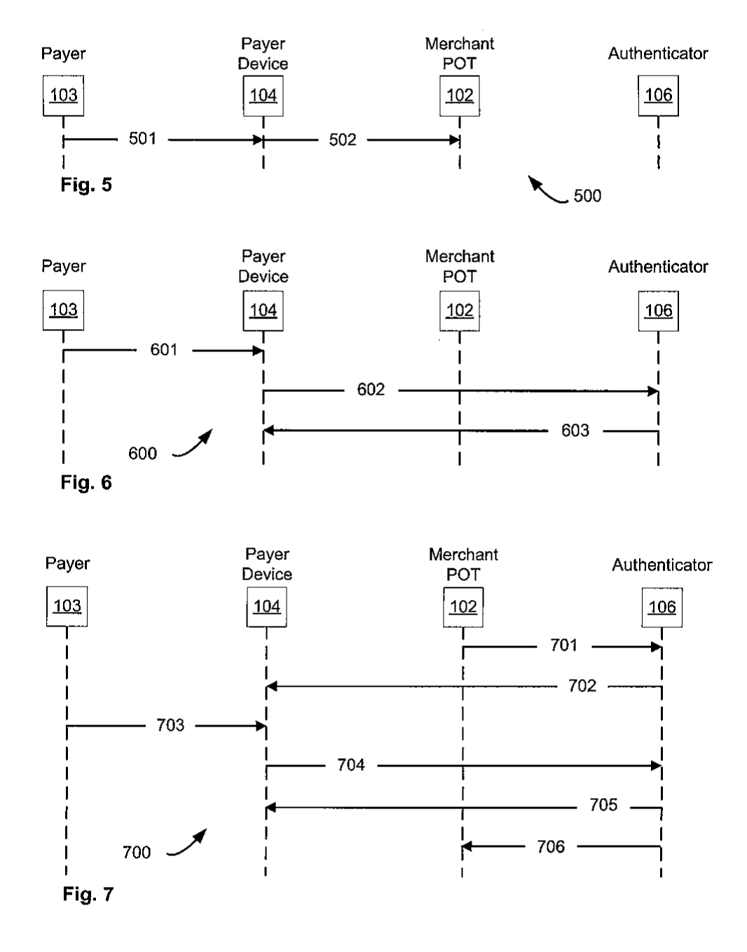

FIGS. 4 and 5 illustrate operations 400 and 500 comprising invocations and message flows representing an identification process for initiating a location-based payment authentication transaction in accordance with some examples. FIG. 4 represents operations to initiate an in-store transaction and FIG. 5 represents operations to initiate an online transaction. Payer 103 indicates that a location-based payment authentication transaction is desired and provides the payer's Payer ID 118 for the POT system 102.

Flow 400 illustrates various manners to provide the Payer 1D 118. The manner of providing the Payer ID 118 for an online transaction may differ from the manner of providing the Payer ID 118 in-store. In-store: the Payer 103 and/or Payer device 104 provides the Payer ID 118 to and/or for Merchant POT system 102 to issue the Bill. Flows 401 and 402 represent Payer 103 invoking device 104 to send the Payer ID 118 to POT system 102. Player device 104 and POT system 102 may communicate network 108 (e.g. through the Internet) via one of multiple cellular technologies (e.g. CDMA and GSM) (network 110), GPS, infrared (IR), NFC, Bluetooth or any other wireless communication link that is available between the Payer device 104 and the Merchant POT system 102 (e.g. path 114). In some examples (flow 403), the Payer ID 118 is given verbally (e.g. path 116) to the Merchant directly to be entered into the POT system 102 or entered manually by Payer 103 into the Merchant POT system 102. In some examples, (404) the Payer ID 118 may be stored in an RFID chip that is on the Payer device 104, printed on a plastic card, key fob or the like that can be read by the Merchant POT system 102 or printed on a QR code, barcode or any other encoded format that is scanned by the Merchant POT system. Merchant POT system 102 and Payer device 104 may be configured to automatically communicate the Payer ID 118, for example, using a short range communication (e.g. via path 114). Device 104 may be discoverable to POT system 102 upon entering the Merchant location.

In another manner (not shown) Payer device 104 may be configured to share its location, for example, with a merchant system and/or Authenticator 106. Upon entering the store, the location of the Payer device may be matched to the location of POT system 102 and the Payer ID 118 provided automatically to the POT system 102. When Payer 103 presents to purchase at the POT system, the Payer ID 118 may be selected (e.g. POT system may present a list of Payers in the store and the Payer may identify her/himself to make the selection).

Online:

In the online context (flows 501 and 502), such as when Payer 103 is shopping electronically via a merchant website having a merchant domain, the Payer can simply provide (e.g. type in or speak) the Payer ID 118 through Payer device 104 via a Merchant payment portal for example, to POT system 102, which in this case represents an online payment system. In another embodiment, the transaction may be a purchase transaction at least partially conducted by telephone with payment information provided via the telephone. The location information may also comprise a domain name address in such a scenario.

In an online purchase, the location of Payer 103 can also be used to further secure the payment. The Payer's location may be an IP address or a geographic address. Payer 103 would be prompted to authorize a payment, such as:
Authorize $27.47 for <some items>, purchased from <abcinc.com>, requested at <Payer's IP address or physical location if available>?
   The IP address or physical location of the Payer are checked at the Authenticator and a warning might be sent back to the Payer in case of a mismatch, or following any other security policy that is in effect.

FIG. 6 illustrates operations 600 for identification in a privacy protecting manner. Payer 103 might desire to be identified to the Merchant via a privacy-protecting identification process. In this process (600), the Payer ID 118 is replaced with a new random ID that changes with every transaction.

At flows 601 and 602, Payer 103 interacts with Payer device 104 to generate a request a new random ID (e.g. a SID) from the Authenticator 106. In the Payer request, the Payer ID 118 along with other authentication parameters (such as a signature, time, date, etc.) is sent to the Authenticator 106. Optionally the location of the Payer and the Merchant ID can be sent to the Authenticator. This is regardless of the Transaction Type and the same process proceeds for both in-store and online payments.

The Authenticator first authenticates the Payer device request. Once the Payer device is authenticated to the Authenticator 106, Authenticator 106 creates a Message Authentication Code (MAC) (such as MD5, SHA1 and SHA256) of the parameters sent in the Payer device's request using the Authenticator's secret(s). Note that the Authenticator's secret(s) is only known to the Authenticator 106. A shorter digest (e.g. which may be used as the SID) of the MAC result may be created by the Authenticator 106. A shorter digest may be easier for a human user to enter. In other embodiments the SID may be long. For example to define a shorter SID, Authenticator 106 might use the last four digits of the MAC result as a short digest. The Authenticator may ensure that the SIDs are unique within a certain time period (T)—(if available) at any given location with a specific Merchant ID. This restriction will guarantee that every SID is associated with one and only one Payer in any T interval and the Authenticator can retrieve the full Payer ID 118 from the SID. Clearly, the Authenticator would have to keep the mapping between SIDs and IDs private and to discard the association between them after T. If there is a collision—i.e. the same SID is obtained from the MAC results of two different IDs—the Authenticator would have to implement an anti-collision scheme. For example, the Authenticator might assign the SID to the Payer who sent the request first while keeping the other Payer(s) waiting to use the same SID. The Authenticator returns the SID to the Payer device via a secure channel (flow 603).

The Payer 103 and/or Payer device 104 provides the SID, instead of its actual Payer ID 118, to the POT system 102 such as by one of the methods described with reference to FIGS. 4 and 5. Once the Merchant POT system 102 receives the Payer ID 118 or SID the location-based payment authentication process may be further undertaken.

FIG. 7 illustrates operations 700 comprising invocation and message flows for location-based payment authentication processing in accordance with an example. Merchant POT system 102 prepares a Bill containing the Transaction Type, Merchant ID, Merchant POT ID, Payer ID 118 or SID, description of the charges and their amount, location of transaction, timestamps and other data that may be necessary to validate the payment and verify the Merchant and its POT system 102. As noted, Transaction Type can be either online or in-store. The Merchant ID uniquely identifies the merchant account, whereas the Merchant POT ID is a unique identifier that determines the Merchant POT system 102 and its registered location. One Merchant might have several POT systems and therefore receive multiple Merchant POT IDs. However, each Merchant POT ID is associated with one location that is to be checked by the Payer 103 before a confirmation for the payment is provided as described. Merchant POT system 102 sends the Bill to the Authenticator 106 for further processing and authentication. The Bill is sent to Authenticator 106 over a secure channel, such as SSL or TLS. The Merchant POT system digitally signs the Bill in order to cryptographically bind the Merchant and its terminal to the Bill sent to the Authenticator 106 (flow 701).

Authenticator 106 receives the Bill and verifies that the digital signature on the Bill is valid and issued from an authorized Merchant. The Bill includes purchase information for the purchase transaction (e.g. amount to be paid etc.) optionally payment information such as payment instrument to be used to pay, Payer ID 118 or SID and location. Authenticator 106 checks the location of the transaction against the registered location of Merchant POT system 102 and also the location of Payer device 104 (if location tracking of Payer device 104 is enabled). Payer ID 118 or SID may be used to look-up information for Payer 103 and Payer device 104 in a database of Authenticator 106. Such information may include a current location of Payer device 104. In some embodiments, such a location may be interrogated from Payer device 104 using information for Payer device 104 stored in the database. Authenticator 106 may stop Bills that are presented in association with incorrect locations (e.g. because Merchant POT system 102 registered with Authenticator 106 does not match the location in the Bill or the location of Payer device 104 does not match such Merchant POT system 102 or Bill location) from being processed before they reach Payer device 1045. Nevertheless, if the location tracking of Payer device 104 is not enabled and the Bills reach Payer device 104, Payer 103 verifies the location of the transaction to authorize the transaction.

Once the Bill is validated at Authenticator 106 and Merchant POT system 102 is verified, Authenticator 106 initiates a transaction and assigns a Transaction ID to it. Then, Authenticator 106 sends (flow 702) the Bill along with the Transaction ID to Payer device 104 for approval over a secure channel. Payer 1D 118 or SID is indicated on the Bill to uniquely identify Payer 103. Authenticator 106 determines Payer device 104 from its records, for example looking up such information using the SID and/or Payer ID 118, Authenticator 106 also adds its digital signature to the Bill as well as a challenge message secured with transaction authorization key (Kᵢ) 132. Authenticator 106 might use any challenge-response technique to generate the challenge message.

Authenticator 106 authenticates the Payer's confirmation to process payments based on two factors. First, Payer device 104 has to have the correct transaction authorization key 132 that is tied to Payer device 104 and is accessible when Payer presents correct personalization credentials (e.g. PIN, biometrics and the like). Secondly, Payer 103 has to have knowledge of the authentication data (e.g. username/password) associated with the Payer's account.

Authenticator 106 is authenticating the Merchant using 3-factor authentication, comprising of the Merchant's private keys, location and authentication credentials. The Merchant's private keys are stored locally (not shown) on the Merchant POT device 102 and might be protected in a virtual secure memory (not shown). The location of Merchant POT system 102 is submitted to Authenticator 106 with every transaction and it is checked against the original location of Merchant POT system 102 recorded at the time of registration and stored in the database of the Authenticator 106. Similarly to Payer, the Merchant also has to present its login credentials to the Authenticator 106 before it can issue Bills.

Authenticator 106 can send the message requesting confirmation using the information for communicating with Payer device 104 stored in the database of Authenticator 106. Various manners of sending the message requesting confirmation may be used as would be understood to a person of ordinary skill in the art, and may include RTP (streaming), SMTP (emails), SMS, REST HTTP, SOAP (database), push notification and the like. A new record can be generated and stored in the database in a table associated with Payer ID 118. Payer device 104 can be notified of the latest message to download via push techniques, pull techniques or combinations thereof.

Payer device 104 receives the Bill and presents it to Payer 103, for example, visually via a display screen or in another manner (audibly or both). Payer 103 verifies that the Bill has been validated by the Authenticator 106. Payer 103 checks the Merchant, location of the transaction and the description of the charges and their amount, the timestamps and other pertaining data to ensure the validity of the transaction. If everything on the Bill is verified, Payer 103 can confirm that the Bill has been originated from the correct Merchant POT system 102 at the indicated location, which is approved by Authenticator 106.

To approve the payment and pay for the Bill, Payer 103 presents a correct authentication data or login credentials (e.g. username/password) to Authenticator 106. Then he/she provides personalization credentials to the Payer device (flow 703), as previously defined in the personalization process described above with reference to FIG. 2. This is considered as an approval process by Payer 103 for Authenticator 106 to process the payment and transfer funds to the Merchant 102. If Payer 103 provides the correct credentials, Payer device 104 releases the transaction authorization key (Kᵢ) 132 to return a correct response to the challenge communicated by Authenticator 106. Payer device 104 prepares a confirmation message to the challenge and sends it back to Authenticator 106. In its confirmation message, Payer device 104 includes Payer ID 118 (or SID), Transaction ID, location (optional), digital signature and the response to the challenge. The confirmation message is sent (flow 704) to Authenticator 106 over a secure channel. In some examples, the confirmation request from Authenticator 106 may include a request to choose a specific payment instrument such as a choice of a payment account that has been previously provided to Authenticator 106. Payer device 104 may present options to permit Payer 103 to choose among debit, credit or other payment instruments, confirming a default instrument, adding a tip amount or returning survey data for example. The confirmation message may also include an identification of the payment instrument with which to make the payment. The confirmation message along with additional data from Payer 103 will be protected via digital signature using the Payer private key 131A and encryption using the public key 131B of the Authenticator 106. Details of the account numbers (e.g. payment instrument details) need not be sent to the Payer device 104.

Authenticator 106 verifies the confirmation message from Payer device 104 and, optionally, determines whether the location of Payer 103 in fact matches the location of the transaction (if the location is provided in the confirmation and the Transaction Type is in-store). If the transaction is confirmed by Payer device 104 and, optionally the location provided matches it is validated, Authenticator 106 validates the digital signature on the additional data and decrypts them to access the data. Authenticator 106 proceeds to further process the payment for funds to be transferred. In some examples, Authenticator 106 may contact applicable payment systems (e.g. gateways (not shown)) providing payment instrument information and other transaction information, to effect transfer of the funds. Authenticator 106 may inform both Payer device 104 and Merchant POT system 102 of the result of the transfer. Authenticator 106 digitally signs the notification messages and sends them (flow 705 and 706) to Payer device 104 and Merchant POT system 102 over secure channels. If the transfer is successful, the transaction is finished.

In an alternative example, location-based payment authentication processing may be integrated into existing credit card payment processes. For example, Payer 103 may present a credit card (e.g. a chip-enabled credit card) to a POT device of Merchant POT system 102, Payer 103 verifies information presented on the POT device 102 such as the amount to be paid, location and the like. Payer 103 may enter Payer's credit card credentials (e.g. PIN).

POT system 102 (which may comprise a POT device) sends the Bill to Authenticator 106, possibly indirectly via a credit card processing system (not shown) that contacts Authenticator 106 with the Bill. In some examples, the credit card processing system performs the role of Authenticator 106. As such, Authenticator 106 or credit card processor system verifies the Bill as previously described herein. If the POT location matches the previously registered (stored) location, and optionally matches the tracked location of Payer device 104, Authenticator 106 or credit card processing system sends the Bill along with request for confirmation to Payer device 104. Payer 103 verifies Bill information, location and if acceptable to the Payer 103, confirms it to Authenticator 106 or credit card processing system as applicable, typically via Payer device 104. Authenticator 106 may provide the confirmation results to the credit card processing system and/or the credit card processing system to process the payment in accordance with the confirmation. A message may be sent to the POT system 102 to conclude (or reattempt) the purchase transaction. In this example, the credit card can act as the Payer ID 118 and be used to look-up information for the Payer 103 and/or Payer device 104.

In other alternative examples, location-based authentication as described may be applied to debit card or other payment instrument transactions. In addition to point of sale purchase transactions, location-based authentication may be employed to confirm withdrawals or other financial transactions at automated teller machines (ATMs) and the like. Payers (e.g. users of the ATM) may be requested to confirm the location of the ATM and optionally be provided with the name of the financial institution and/or at least some of the information related to the financial transaction. For example, Payer may be asked to confirm “Authorize Transfer $XXXX from Checking to Savings Account at FI_BANK, ATM location 123 Main Street, Anytown, State?”.

The scope of the claims should not be limited by the examples provided herein, but should be given the broadest interpretation consistent with the description as a whole.

1. A method for authenticating a financial transaction, comprising:
sending to a payer communication device financial information including location information related to the financial transaction and requesting confirmation of the financial transaction in association with the location;
receiving from the payer communication device the confirmation; and
in accordance with the confirmation, approving further processing of the financial transaction.

2. The method of claim 1 wherein the financial transaction is a purchase transaction comprising a payment to be made using a point of transaction (POT) system; and the location information comprises a geographic address for the point of transaction.

3. The method of claim 1 wherein the financial transaction is one of:
an e-commerce purchase transaction with payment made online or
a telephone purchase transaction with payment made via the telephone;
and the location information comprises a domain name address.

4. The method of claim 1 comprising receiving from a POT system the financial information including the location information.

5. The method of claim 4 comprising verifying the location information received against location information previously registered for the POT system.

6. The method of claim 4 wherein the financial information received from the POT system further comprises an identifier for the payer and wherein the method further comprises using the identifier to determine the payer communication device.

7. The method of claim 1 wherein the confirmation received comprises a response to a challenge secured by a transaction authorization key.

8. The method of claim 7 comprising sending a transaction authorization key to the payer communication device for secure storage on the device such that the transaction authorization key can only be accessed from the device via authorized applications by verified users.

9. The method of claim 1 wherein the confirmation received comprises an identification of a payment instrument with which to make a payment.

10. The method of claim 1 wherein approving further processing comprises initiating further processing of a payment in accordance with the confirmation.

11. The method of claim 10 comprising sending to a payment system purchase information for the financial transaction comprising payment information for processing the payment.

12. The method of claim 11 wherein the payment information includes payment instrument information with which to make the payment.

13. The method of claim 12 comprising receiving from the payer communication device an identification of the payment instrument.

14. The method of claim 1 comprising:
receiving from the payer communication device a request for a temporary identifier for a payer of the financial transaction;
generating a temporary identifier and associating the temporary identifier with payer information previously stored for the payer; and
sending to the payer communication device the temporary identifier for use to initiate the financial transaction.

15. The method of claim 14 wherein the temporary identifier is uniquely shortened to facility communication by a payer to a POT system or online purchase system to initiate the financial transaction.

16. The method of claim 14 comprising receiving from a point of transaction (POT) system or online purchase system purchase information for the financial transaction including the location information and the temporary identifier; and using the temporary identifier to access the payer information.

17. (canceled)

18. A computer program media storing instructions for configuring a programmable device to perform the method of claim 1.

19. A method for confirming a financial transaction, the method comprising
receiving, from an apparatus for authorizing a financial transaction, at a communication device, a request to confirm financial information including location information related to the financial transaction; and
sending to the apparatus a confirmation for the financial transaction thereby to permit or deny further processing.

20. (canceled)

21. (canceled)

22. (canceled)

23. (canceled)

24. The method of claim 19 comprising receiving payer credentials from a payer at the payer device for generating the confirmation thereby to authenticate the payer using two factor authentication.

25. The method of claim 24 wherein the confirmation generated comprises a response to a challenge from the apparatus, the confirmation secured by a transaction authorization key.

26. (canceled)

27. (canceled)

28. (canceled)

29. (canceled)

30. (canceled)
